(19) United States
(12) Patent Application Publication
(10) Pub. No.: US 2008/0200597 A1
(43) Pub. Date: Aug. 21, 2008

(54) Pva-Containing Compositions

(76) Inventor: Peter Morris, Cirencester (GB)

Correspondence Address: STITES & HARBISON PLLC, 1199 NORTH FAIRFAX STREET, SUITE 900, ALEXANDRIA, VA, 22314, US

(21) Appl. No.: 11/813,951

(22) PCT Filed: Jan. 13, 2006
(86) PCT No.: PCT/GB2006/000125

§ 371 Date: Feb. 19, 2008

(30) Foreign Application Priority Data
Jan. 13, 2005 (GB) 0500662.2

(51) Int. Cl. C08K 5/053

(52) U.S. Cl. 524/388

(57) ABSTRACT

A PVA-containing composition comprises, by weight 40 to 97% PVA and 3 to 20% plasticiser comprising glycerine and propylene glycol. Optionally at least one of a filler, a binder and a pigment such that the total amount is 100%. Preferably, the composition comprises 50 to 67% PVA and 5 to 17% of the plasticiser. The plasticiser preferably comprises at least 1% of glycerine and at least 1 % propylene glycol, more preferably in a ratio, by weight, of glycerine to propylene glycol of 1:5 to 5:1.

The present invention relates to PVA-containing compositions. Methods of making such compositions and methods of extruding PVA-containing compositions are also disclosed.

### TECHNICAL FIELD

There is currently a significant and increasing demand for bio-degradable polymers, to replace non bio-degradable polymers which take up an ever greater amount of disposal space, such as land-fill, or need to be incinerated.

### BACKGROUND ART

Polyvinylalcohol (PVA) is one bio-degradable polymer which is in widespread use. As a film, PVA shows a high degree of impermeability to a number of gases. Incorporated into adhesive, PVA shows high adhesive strength. PVA has significant potential in a wide range of products.

While attempts have been made to extrude articles from PVA, it has been found that melt extruded PVA becomes very unstable and significant residues become adhered to the surfaces of the extrusion apparatus, requiring very careful control of process conditions, specialised extrusion apparatus and frequent shut down of the extrusion process and purging of the apparatus. Examples of PVA-containing compositions and methods of making thereof which at least substantially overcome problems in extruding PVA-containing compositions are disclosed in our UK Patent Numbers GB-A-2340835 and GB-A-2378705, both of which are incorporated herein by reference.

The search for biodegradable polymers is acute in relation to certain sanitary products such as diapers and sanitary towels. However, these products typically comprise superabsorbent materials and at present such materials are only available in combination with conventional non bio-degradable polymers.

Other disadvantages in the prior art include problems with trying to increase flexibility of products made by PVA-based polymers. One method of increasing flexibility is to add plasticiser to the plastic composition. However, if the amount of plasticiser added is greater than a predetermined threshold amount, the resulting chemical composition tends to be chemically unstable, and “sweats out” the plasticier. This results in the product becoming internally brittle.

### SUMMARY OF THE INVENTION

There are disclosed herein PVA-containing compositions, methods of manufacturing the same and methods of extruding PVA-containing compositions which overcome or at least ameliorate some of the disadvantages identified in the art.

Aspects of the invention are set out in the independent claims. Preferred features of the invention are set out in the dependent claims.

The compositions disclosed herein include a plasticiser, which lowers the melt temperature of the polymer under extrusion and increases the flexibility of the extruded product. The plasticiser comprises a mix of glycerine and propylene glycol. The inventors have found that typically when more than about 6% glycerine by weight is used as a sole plasticiser in the mixture, sweating of plasticiser from a product extruded using the mixture occurs. Similarly, sweating occurs typically when more than about 10% propylene glycol by weight is used as a sole plasticiser in the mixture. This can be problematic when a higher degree of flexibility of extruded or moulded product is required than is obtainable from the use of less than about 6% glycerine or less than about 10% propylene glycol as plasticiser. Surprisingly and counter intuitively, the inventors have found that if a mix of glycerine and propylene glycol is used as the plasticiser, a greater percentage weight of plasticiser can be introduced to the mix before sweating may occur, thus providing greater flexibility of an extruded product with no sweating, compared with using single component plasticisers. Thus a combined benefit of each of propylene glycol and glycerine is surprisingly achieved by using the mixed plasticiser. While it is not essential that sweating not occur, it is desirable and may be required in certain applications.

There is disclosed herein a PVA-containing composition preferably comprising a blend of PVA, plasticiser comprising glycerine and propylene glycol and an amount of lubricant, or binder, effective to render the blend extrudable.

In alternative embodiments, the plasticiser, in addition to glycerine and propylene glycol, further comprises as the plasticiser one or more of: ethylene glycol; triethylene glycol; low molecular weight polyethylene glycols; and low molecular weight amides.

The lubricant may comprise a fatty acid amide, the resultant composition blend being suitable for extrusion in conventional melt-extrusion apparatus. In preferred embodiments disclosed herein, a PVA-containing composition comprises greater than 3% and less than 20% plasticiser and up to 5% binder, by weight.

The above composition is thus an extrudable and formable PVA-containing plastic, typically with a flexural modulus similar to other extrudable polymers. Known advantageous properties of PVA, such as its high tensile strength, good puncture resistance, and good barrier characteristics are retained in an extrudable composition which can be processed on current extrusion lines, blow-moulders and injection moulders without modification, and without the processing problems such as thermal degradation and high temperature cross linking, observed in attempts to extrude articles using hitherto known PVA-containing compositions.

In embodiments disclosed herein, extrudable PVA-containing compositions have been obtained comprising fully hydrolysed PVA as well as partially hydrolysed PVA, and including PVA that is 70% or more hydrolysed.

Further embodiments disclosed herein provide PVA-containing compositions in which the molecular weight of the PVA varies from around 20,000, in some cases from around 10,000, to greater than 150,000. Generally, the application of the disclosed technique is not limited to PVA of any particular percent hydrolysis nor of any particular molecular weight.

The PVA-containing composition disclosed herein preferably comprises a blend of PVA plus filler. In this composition, the filler is effectively a bulking agent and is relatively inexpensive compared to the PVA, thus a composition is obtained retaining advantageous properties of PVA whilst being cheaper per unit weight to produce.

Preferably the PVA-containing compositions are provided in the form of pellets or tablets. These preferably have a size of between about 1 mm and 5 mm in diameter and are suitably obtained by a method in which PVA, preferably substantially uncompounded and in powder or granular form, is mixed with lubricant and filler and other compounding ingredients, and cold pressed to form a tablet or pellet. This cold-pressing method is substantially as described in WO-A-98/26911 in relation to different polymers.

With this method, the ingredients can be uniformly mixed and compounded in the correct proportions for the final product, and made into a form that is easier to handle than powder. In addition, since the mixture is cold pressed rather than melted, problems of thermal degradation or variation in properties are reduced.

References to “cold pressing” are intended to imply applying pressure to the powder to cause agglomeration without substantial melting of the polymer. The temperature is preferably less than about 100 degrees Celsius, more preferably less than about 70-80 degrees Celsius. Preferably heat is not applied directly to the mixture. However, heat may be generated by mixing and/or pressing, and this may be allowed to warm the mixture, or cooling may be provided. It is permissible for some heat to be applied directly if necessary to facilitate binding. Some melting of the polymer or other ingredients may occur, particularly on a microscopic scale as a result of pressure at the interface between adjacent particles, but it is important that the bulk of the polymer granules do not liquefy.

Preferably, the mixture is compressed in discrete quantities into tablets or pellets, for example in a tablet press; this may provide more reliable agglomeration.

However, it is possible for the mixture to be extruded under pressure through an orifice, the pellets forming following exit of the mixture from the orifice. For example, the mixture may be extruded under pressure through an orifice into a mould in an injection moulding process. In any such case, binder or moisture may be added to the mixture, preferably as the mixture is extruded, or after preliminary mixing of the constituents.

Preferably, the mixture is substantially dry, but includes sufficient residual moisture to bind the tablets or pellets on pressing. This avoids the need to add a separate binder, and allows the tablets or pellets to be broken more easily as they enter the extruder simply by drying them further. When water is relied upon for binding, it is desirable to ensure that the tablets or pellets are dried prior to extruding, for example at between 40 and 80 degrees Celsius for 4-8 hours; this alleviates problems of vapour formation during extrusion. The moisture content is desirable to form the tablets, but after forming, the tablets should in most cases retain their shape even when dried.

Preferably, the moisture content is less than about 10% by weight, and preferably greater than 0.01% by weight, more preferably less than about 5%. If the pellets or tablets are extruded or otherwise formed at relatively low pressures, however, the moisture content may be about 20% or even higher to ensure binding. If the pellets are too moist, they may tend to stick together, inhibiting flow, and drying after forming may be desirable.

The moisture may comprise residual moisture in the polymer or in one or more of the compounding ingredients. In this way, moisture can be provided automatically simply by not drying the ingredients fully prior to mixing.

It is preferred that the PVA-containing composition is extrudable, and hence the PVA-containing composition further comprises an effective amount of a lubricant to render the composition extrudable. The lubricant may comprise a fatty acid amide or a plasticiser or a mixture of both a fatty acid amide and a plasticiser.

The lubricant in compositions disclosed herein is provided so as to improve the thermal stability of the composition under extrusion. The lubricant may be referred to as an internal lubricant, in that its function is to improve lubrication between the polymer chains. Compositions disclosed herein may be intended for use in or in connection with food stuffs, and hence it is preferred that the lubricant is approved for food use. It is further preferred that the lubricant is a fatty acid amide, and particularly a straight or branched C₁₂-C₂₄ fatty acid amide, more particularly C₁₆-C₂₀. Particularly and surprisingly good results are obtained if the lubricant comprises stearamide, a straight chain C₁₈ fatty acid amide.

While the proportion of components present may vary in compositions disclosed herein, embodiments disclosed herein may comprise, by weight, 20 to 49% filler and 0.5 to 1.5% internal lubricant. More particular embodiments disclosed herein comprise, by weight, 20-30% filler, 40-70% PVA, 0.5 to 1.5% internal lubricant and 5-15% plasticiser.

Compositions disclosed herein are thus extrudable and formable, but it may be that ease of extrusion depends partly upon the state of the extrusion apparatus, in particular the roughness of surfaces in the apparatus. The composition further comprises an additional lubricant, which may be referred to as an external lubricant, to prevent or reduce adhesion of the composition to such surfaces. This external lubricant is present at 0.001 to 0.1% by weight of the composition and preferably approved for food use, in the same way as the internal lubricant. Stearate salts are suitable external lubricants, in particular magnesium, lead or zinc stearates. These lubricants may also be considered as binders.

Fillers for incorporation into compositions disclosed herein may suitably be selected from conventional polymer fillers. Typically the filler is an inert, inorganic material and a particularly preferred filler is or comprises talc, calcium carbonate. In a specific embodiment disclosed herein, this talc may be micronised, such as in particles with a mean size of about 20 microns and may further be coated, such as with a stearate. One such coated, micronised talc is available from Croxton and Gary as 90T (trade mark of Croxton and Gary).

It is further an option for the filler to comprise or consist of a superabsorbent material. In a specific example described below, a filled PVA-containing composition comprises a superabsorbent which contains cross-linked sodium polyacrylate (available from Alloid Colloids as SALISORB CL31 (registered trade mark)). Filled compositions disclosed herein may nevertheless contain superabsorbent material of substantially any type. Incorporation of such superabsorbent material confers the particular advantage that sanitary products such as diapers and sanitary towels, hitherto major components of waste storage sites such as land-fill sites, may now be made of or comprise a significant proportion of bio-degradable material.

A number of water-absorbent compositions are known and suitable for use as the filler. For example, U.S. Pat. Nos. 3,954,721 and 3,983,095 disclose preparations for derivatives of copolymers of maleic anhydride with at least one vinyl monomer in fibrous form. The fibrous copolymers are rendered hydrophilic and water-swellable by reaction with ammonia or an alkali metal hydroxide. U.S. Pat. No. 3,810,468 discloses lightly cross-linked olefin-maleic anhydride copolymers prepared as substantially linear copolymers and then reacted with a diol or a diamine to introduce cross-linking. The resultant lightly cross-linked copolymers are treated with ammonia or an aqueous or alcohol solution of an alkali metal hydroxide. U.S. Pat. No. 3,980,663 describes water-swellable absorbent articles made from carboxylic polyelectrolytes via cross-linking with glycerine diglycidyl ether. These patents are incorporated herein by reference.

European Published Application No. 0 268 498 (incorporated herein by reference) describes a water-absorbent composition formed by causing a substantially linear polymer of water-soluble ethylenically unsaturated monomer blends comprising carboxylic and hydroxylic monomers to cross-link internally.

Further examples of water-absorbent compositions are those produced from a copolymer of an α,β unsaturated monomer having at least one pendant unit selected from a carboxylic acid group and derivatives thereof and a copolymerisable monomer. A proportion of the pendant units are present in the final copolymer as the free acid and a proportion as the salt of the acid. These copolymers are capable of being cross-linked, either internally or with a variety of cross-linking agents, to form the water-swellable composition. Examples of water-swellable compositions of this type can be found in U.S. Pat. Nos. 4,616,063, 4,705,773, 4,731,067, 4,743,244, 4,788,237, 4,813,945, 4,880,868 and 4,892,533 and European Patent Nos 0 272 074 and 0 264 208 and European Published Application No. 0 436 514 which are incorporated herein by reference.

Derivatives of carboxylic acid groups include carboxylic acid salt groups, carboxylic acid amide groups, carboxylic acid imide groups, carboxylic acid anhydride groups and carboxylic acid ester groups.

Other examples of water-absorbent compositions can be found in U.S. Pat. No. 4,798,861, WO 93/17066, WO 93/255735, WO 93/24684, WO 93/12275, European Published Application Nos 0 401 044, 0 269 393, 0 326 382, 0 227 305, 0 101 253, 0 213 799, 0 232 121, 0 342 919, 0 233 014, 0 268 498 and 0 397 410, British Patent Application Nos 2 082 614, 2 022 505, 2 270 030, 2 269 602 and 2 126 591, U.S. Pat. Nos. 4,418,163, 4,418,163, 3,989,586, 4,332,917, 4,338,417, 4,420,588 and 4,155,957 and French Patent Application No. 2 525 121 which are all incorporated herein by reference. The extrudable compositions disclosed herein are suitable for manufacture of substantially any article made using currently extrudable polymers, including films and bottles and any other articles. The compositions are suited to manufacture of filaments and fibre, for use in spunbond, non-woven and melt-blown applications. The composition is suitable also for manufacture of such articles as agri-chem sachets, mulch films, plant pots, domestic bags, diapers, drinking straws, fem care products, hangers, incontinence pads, sachets, six pack rings, disposable clothing, expanded foams, gloves, film canisters, golf tees, wads and sleeves for shot gun cartridges, bed pans, bottles, bowls, cotton buds, hospital curtains, “one-use” sterile products and packaging materials.

Furthermore, references to “extrusion” are not to be interpreted narrowly to mean traditional extrusion processes, but include screw blending, injection moulding, etc, where the PVA-containing composition is moved through a port, and/or into a die or mould, or similar.

Particularly good results have been obtained with PVA-containing compositions having the following make-up, by weight:
(a) 40 to 70% PVA;
(b) 20 to 49% filler, preferably a micronised inorganic material such as talc, preferably coated with stearate;
(c) 5 to 15% plasticiser comprising glycerine and propylene glycol;
(d) 0.5 to 1.5% internal lubricant, preferably zinc stearate and calcium stearate; and
(e) 0.0001 to 0.1% external lubricant, preferably stearate.

The internal and external lubricants may also be considered as binders. The composition may contain residual moisture, sufficient to enable the composition to be bound as a cold-pressed tablet.

Another preferred embodiment of the invention comprises, by weight:
50 to 60% PVA;
30 to 40% stearate-coated calcium carbonate;
10 to 15% plasticiser comprising glycerol and propylene glycol;
0.5 to 1.5% octadecanamide; and
0.0001 to 0.1% zinc stearate.

There is also disclosed herein a method of making an extrudable PVA-containing composition comprising blending PVA with plasticiser comprising glycerine and propylene glycol, and preferably with a lubricant, or binder, and a filler.

The amount of lubricant blended with the PVA is typically restricted by the fact that, above a certain percent, excess lubricant separates out from the blend, and lubricant is blended 0.5 to 1.5% by weight of the PVA present. The method thus conveniently enables tablets or pellets of the composition to be prepared as the feedstock for an extrusion. Blending of the components of the composition is achieved using conventional apparatus, one such example being a high speed blender.

The method may optionally comprise adding small amounts of moisture to the components to be blended, such as by dripping water into the blend. Preferably, components of the PVA-containing composition are fed into a high speed mixer gravimetrically.

There is also disclosed herein a method of making a PVA-containing composition comprising blending PVA, plasticiser comprising glycerine and propylene glycol, a lubricant and a filler, wherein the filler comprises a superabsorbent material, such as calcium carbonate, for example. It is preferred that blending is carried out in the presence of sufficient moisture to bind the composition into tablets or pellets upon cold pressing, the moisture optionally being present in the starting materials of the blend or being introduced into the blend, such as by drip-feeding.

There is also disclosed herein a method of extruding a PVA-containing composition so as to form an extruded product which contains PVA, comprising:
blending PVA with a plasticiser consisting of glycerine and propylene glycol; and
cold pressing the resultant blend into pellets or tablets;
wherein the pellets or tablets comprise the polymer feedstock for extrusion of an extruded product and/or moulding a product containing PVA with a predetermined degree of flexibility.

The PVA is preferably also blended with one or more lubricant and filler components in the presence of sufficient moisture to bind the blend upon cold pressing. An advantage of the method is that the PVA-containing feedstock for the extrusion step is obtainable substantially without melting of the PVA. This improves the stability of the PVA during subsequent extrusion. Hitherto, as has been recognised by the present inventor, attempts to extrude a PVA-containing feedstock largely failed as the PVA already had a heat history, ie had been wholly or partially melted in processing stages prior to the extrusion stage. Preferred techniques disclosed herein avoid the disadvantage of introducing such a heat history into the PVA-containing composition. Preferably, the plasticiser consists of glycerine and propylene glycol.

Optional and preferred features mentioned above are optional and preferred features of all techniques disclosed herein.

### DETAILED DESCRIPTION OF THE PREFERRED EMBODIMENTS

### EXAMPLES

The invention is now described in the following non-limiting examples.

Ten PVA-containing compositions with different % weight amounts of plasticiser and filler were blended and articles injection moulded for each composition using the same mould. Each article was tested and compared for relative flexibility using a scale of 1 to 10, where 1 is brittle and 10 is flexible. The upper limit (10) of the flexibility scale was set by the article having the most flexibility.

In each example, the binder used was a combination of stearamide and zinc stearate, the pigment was titanium dioxide and the filler was calcium carbonate.

### Comparative Examples 1 to 3

| | | | Example 3 |
|---|---|---|---|
| | Example 1 | Example 2 | (% |
| Component | (% weight of total) | (% weight of total) | weight of total) |
| PVA | 55 | 55 | 55 |
| Binder | 5 | 5 | 5 |
| Pigment | 2 | 2 | 2 |
| Glycerine | 3 | 6 | 10 |
| Filler | 35 | 32 | 28 |
| Flexibility | 0.1 | 2 | 6 |

In comparative examples 1 to 3, glycerine only was used as the plasticiser.

### Comparative Examples 4 to 6

| | | | Example 6 |
|---|---|---|---|
| | Example 4 | Example 5 | (% weight |
| Component | (% weight of total) | (% weight of total) | of total) |
| PVA | 55 | 55 | 55 |
| Binder | 5 | 5 | 5 |
| Pigment | 2 | 2 | 2 |
| Propylene Glycol | 3 | 6 | 10 |
| Filler | 35 | 32 | 28 |
| Flexibility | 0.1 | 0.3 | 2 |

In comparative examples 4 to 6, propylene glycol only was used as the plasticiser.

### Examples 7 to 10

| | Example 7 | Example 8 | Example 9 | Example 10 |
|---|---|---|---|---|
| | (% weight | (% weight | (% weight | (% weight |
| Component | of total) | of total) | of total) | of total) |
| PVA | 55 | 55 | 55 | 55 |
| Binder | 5 | 5 | 5 | 5 |
| Pigment | 2 | 2 | 2 | 2 |
| Glycerine | 5 | 5 | 5 | 5 |
| Propylene | 0 | 3 | 6 | 10 |
| Glycol | | | | |
| Filler | 33 | 30 | 27 | 23 |
| Flexibility | 1 | 3 | 5 | 8 |

Examples 7 to 10 illustrate the change in flexibility as propylene glycol is added to the mix.

As explained above, the inventors have found that typically when more than about 6% glycerine by weight is used as a sole plasticiser in the mixture, sweating of plasticiser from a product extruded using the mixture occurs. Similarly, sweating occurs when more than typically about 10% propylene glycol by weight is used as a sole plasticiser in the mixture. This can be problematic when a higher degree of flexibility of extruded or moulded product is required than is obtainable from the use of less than about 6% glycerine or less than about 10% propylene glycol as plasticiser. Surprisingly and counter intuitively, the inventors have found that if a mix of glycerine and propylene glycol is used as the plasticiser, a greater % weight of plasticiser can be introduced to the mix before sweating may occur, thus providing greater flexibility of an extruded product with no sweating, compared with using single component plasticisers. Thus a combined benefit of each of propylene glycol and glycerine is surprisingly achieved by using the mixed plasticiser. The increase in flexibility is evident on review and comparison of the results from the above Tables 1 to 3.

Articles formed from the compositions of examples 1 and 4 to 10 above did not appear to show sweating of plasticiser.

As will be understood, similar results are obtained, particularly in terms of relative flexibility and relative addition of plasticiser, when making PVA-containing compositions within the scope of the amounts provided through the specification and claims. For example, similar results are achieved when the composition contains, by weight, 50 to 67% PVA. Also, similar results may be achieved when using proportionally more glycerine, by weight, than propylene glycol.

As far as extrusion apparatus is concerned, it is advantageous to use chrome plated screws and for the melt flow path to use chrome plated surfaces and gradual tapers to streamline the melt.

The invention thus provides PVA-containing compositions for use in the manufacture of biodegradable articles which can achieve a higher degree of flexibility with no plasticiser sweating, when compared with prior art biodegradable plastics.

While the present invention has been described in its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

The text of the abstract filed herewith is repeated here as part of the specification.

A PVA-containing composition comprises, by weight 40 to 97% PVA and 3 to 20% plasticiser comprising glycerine and propylene glycol. Optionally at least one of a filler, a binder and a pigment such that the total amount is 100%. Preferably, the composition comprises 50 to 67% PVA and 5 to 17% of the plasticiser. The plasticiser preferably comprises at least 1% of glycerine and at least 1% propylene glycol, more preferably in a ratio, by weight, of glycerine to propylene glycol of 1:5 to 5:1.

1. A PVA-containing composition comprising, by weight:
40 to 97% PVA;
3 to 20% plasticiser comprising glycerine and propylene glycol; and
optionally at least one of a filler, a binder and a pigment such that the total amount is 100%.

2. The composition of claim 1 comprising, by weight:
50 to 67% PVA; and
5 to 17% of said plasticiser.

3. The composition of claim 1 comprising, by weight, 10 to 15% of said plasticiser.

4. The composition of claim 1 wherein the composition comprises, by weight, at least 1% of glycerine and at least 1% propylene glycol.

5. The composition of claim 1 wherein the ratio, by weight, of glycerine to propylene glycol in said plasticiser is 1:5 to 5:1.

6. The composition of claim 5 wherein said ratio is 1:3 to 3:1.

7. The composition of claim 6 wherein said ratio is 1:2 to 2:1.

8. The composition of claim 1 wherein the composition comprises, by weight, more propylene glycol than glycerine.

9. The composition of claim 8 wherein the composition comprises, by weight, about twice as much propylene glycol than glycerine.

10. The composition of claim 1 comprising, by weight:
up to 5% binder; and
up to 49% filler.

11. The composition of claim 10 wherein the binder comprises a fatty acid amide and/or a stearate.

12. The composition of claim 10 wherein the binder comprises stearamide, and one or both of zinc stearate and calcium stearate.

13. The composition of claim 1, in the form of one or more tablets or pellets obtainable by cold-pressing.

14. The composition of claim 1 wherein the filler comprises calcium carbonate.

15. The composition of claim 1 having a moisture content less than about 10%, by weight.

16. The composition of claim 15 having a moisture content greater than about 0.01%, by weight.

17. The composition of claim 1 wherein the PVA has a molecular weight of at least about 10,000.

18. The composition of claim 1 wherein the PVA is partially hydrolysed.

19. The composition of claim 1 wherein the plasticiser consists of glycerine and propylene glycol.

20. A method of making a PVA-containing composition, comprising blending a mixture of, by weight:
40 to 95% PVA; and
3 to 20% plasticiser comprising glycerine and propylene glycol.

21. The method of claim 20 wherein said blending said mixture comprises blending, by weight:
50 to 67% PVA; and
5 to 17% of said plasticiser.

22. The method of claim 20 wherein said blending said mixture comprises blending, by weight, 10 to 15% of said plasticiser.

23. The method of claim 20 wherein the composition comprises, by weight, at least 1% of glycerine and at least 1% propylene glycol.

24. The method of claim 20 wherein the ratio, by weight, of glycerine to propylene glycol in said plasticiser is 1:5 to 5:1.

25. The method of claim 24 wherein said ratio is 1:3 to 3:1.

26. The method of claim 25 wherein said ratio is 1:2 to 2:1.

27. The method of claims 20 wherein the composition comprises, by weight, more propylene glycol than glycerine.

28. The method of claim 27 wherein the composition comprises, by weight, about twice as much propylene glycol than glycerine.

29. The method of claim 20 wherein said blending said mixture comprises blending, by weight:
up to 5% binder and up to 49% filler.

30. The method of claim 29 wherein the binder comprises a fatty acid amide and a stearate.

31. The method of claim 29 wherein the binder comprises stearamide, and one or both of zinc stearate and calcium stearate.

32. The method of claim 20 comprising the step of pressing the composition into tablets or pellets.

33. The method of claim 20 wherein the plasticiser consists of glycerine and propylene glycol.

34. (canceled)
